(19) United States
(12) Patent Application Publication
(10) Pub. No.: US 2007/0052368 A1
(43) Pub. Date: Mar. 8, 2007

(54) Lighting fixture and method for operating same

(76) Inventors: Darras Gilles, Cheureuse (FR); Maillach Pascal, Arcueil (FR)

Correspondence Address: DAVID A. GUERRA;INTERNATION PATENT GROUP, LLC, 2025 17TH AVENUE N.W., CALGARY, AB, T2M 0S7, CA

(21) Appl. No.: 10/595,490

(22) PCT Filed: Oct. 19, 2004
(86) PCT No.: PCT/IB04/03819

§ 371 Date: May 15, 2006

(30) Foreign Application Priority Data
Oct. 21, 2003 (NO) 20034700

(51) Int. Cl. H05B 41/24; H05B 41/16

(52) U.S. Cl. 315/246

(57) ABSTRACT

A ballast for fluorescent tubes and the use thereof for producing fluorescent tube lighting fixtures using a novel gas excitation mode in which light is generated by means of controlled pulses leading to an increased power efficiency, with a data collection and transmission functionality, are disclosed.

This invention relates in general to fluorescent lighting luminaries and more particularly to a new operating mode of fluorescent tubes in a luminary.

A fluorescent tube is a discharge glass bulb whose inner side is covered with fluorescent layer that reacts by emitting visible light when excited by ultraviolet radiation sourced from the gas medium that fills the bulb. Such a gas contains very low pressure mercury vapor.

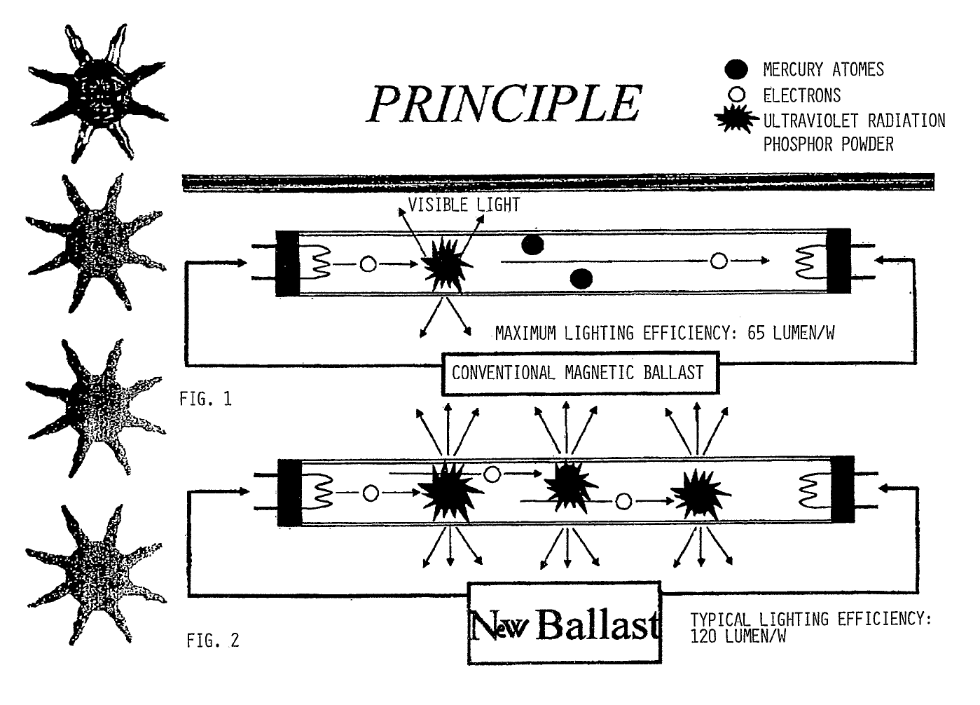

FIG. 1 is a diagram describing the principle of construction and operation of a single fluorescent tube luminary. A flux of electrons, crossing the tube between the two electrodes placed at each end, excites mercury atoms and produces ultraviolet radiation. These electrodes consist of electron thermo-emissive filaments (called pre heating Cathodes) that must heat to incandescent. The alternative main current voltage is used to supply power to the cathodes through a high inductive coil (called Ballast) included to the circuit, that limits the current drawn by the low impedance ionized gas to an acceptable value.

Igniting the conduction through the gas requires a special device (called Starter) connecting the heating filaments directly one to the other, in parallel with the gas medium (see FIG. 1, low section). The starter may consist of a filament bulb including a switch reacting to temperature opened at normal temperature. When the power is applied to the circuit, the current starter bulb lights on and internal temperature goes up rapidly while the cathodes of the fluorescent tube are incandescent. When the temperature is high enough, the switch closes, short cutting the starter which rapidly decreases in temperature and thus opens again the switch. Interrupting suddenly the current induces a high voltage surge at coil's outputs (self induction effect) igniting conduction between the two cathodes, through the mercury vapor heated by the incandescent filaments. From this point, the starter is no more activated as long as the conduction of the vapor remains. The filaments of the cathodes stay incandescent due to their construction and position that drive a part of the current crossing the tube to flow through their surface also hit by mercury ions that help to maintain temperature by dissipating collision energy.

As conduction is ignited and current stabilizes, tube's impedance decreases significantly. Due to its value of impedance at operating frequency of the main power, the ballast coil ensures proper current limitation. Such a system is defined as “magneto-inductive ballast”.

However, some evolutions exist in ballast technology that improve the simple description above, and stated in FIG. 1.

Generally, a ballast is serial impedance that stabilizes the current in the fluorescent tube, usually, as mentioned above, simple inductors are used as ballasts because they operate as reactances with small losses when serial coupled to the tube. Some magnetic ballasts provide more features than serial impedance for the tube like for instance transformers for increasing voltage levels.

In the goal of energy saving, other types of ballast have been developed applying solutions that use semiconductors. This more sophisticated design brought also possibilities to use operating frequencies higher than conventional 50/60 Hz from main electric supply. Frequency in the range of 25 kHz has been employed. Examples of electronic Ballast design are described in patents WO 00/21342 published April 2000, WO 99/05889 published February 1999, WO 97/33454 published September 1997, WO 99/60825 published November 1999, WO 98/34438 published August 1998 and EP-O-955794-A2 published November 1999. Exposed solutions relate mainly to current savings and life time improvement of fluorescent tubes by optimizing different parameters such as waveform, voltage amplitude . . . etc.

U.S. Pat. No. 6,262,542 discloses an electronic Ballast including a lamp driving circuit having a pulse width modulated signal generator to control the duty cycle of the square wave form current flowing through the lamp. What is interesting to point out is not the current flowing through the lamp but moreover a control signal that is included into the circuitry for monitoring the lamp operation. It is also to note that lamp coupling method as described in U.S. Pat. N0. 6,262,542 forces the current to flow through the cathode's filaments.

U.S. Pat. No. 4,902,939 discloses a driving circuitry dedicated to avoid light flickering when witching on and off the power from minimum to maximum variable lighting intensity. Obviously the objective is not to increase the power efficiency of fluorescent lamps. The major difference with the invention is that the driving voltage described in U.S. Pat. No. 4,902,939 consists of sinusoidal waveforms directly derived from main power supply.

Although existing electronic ballasts intend to bring energy savings through their operating modes of fluorescent tubes as well as to extend life time of fluorescent lamps, considerable research and development remain to be done in this domain. The invention discloses a particular brand new operating mode for fluorescent tubes that reduces current drawn by the lamp for 40% to 50% regarding to conventional magnetic ballasts mostly installed in fluorescent lighting fixtures.

In addition, life time of tubes driven by the invention increases for up to 3 times and light emitted does not flicker or suffer stroboscopic effect.

Above benefits are obtained by operating fluorescent luminaries the way disclosed in the invention, such luminaries including one or more standard fluorescent tubes that contain mercury vapor gas and heating filament cathodes at ends, a fixture that integers proper holding and connection devices for fluorescent tubes and one ballast for driving the fluorescent tubes. Ballast operating mode differs from existing systems by the fact that it uses voltage pulses applied to the electrodes for exciting the fluorescent gas, such pulses consisting of non periodic voltage levels separated by variable duration dead times.

In a preferred implementation, the ballast generates pulses composed of perfectly alternate voltage amplitudes. The ballast is also able to control the timing of pulses as well as the dead times by using programmed algorithms. Another benefit can result in monitoring dead times between pulses from real time samplings of the current in the tube. Special coupling installed in tube's connections are controlled by the ballast to short cut cathode's filaments on right time, in order to cancel any current flow through it and so avoid losses of voltage. Ignition of conduction in the tube can profit of temporarily connecting a capacitor that seriously increases voltage at ends of every fluorescent tube and is disconnected as soon as the conduction establishes. The ballast modifies the current in the tube after the conduction happens in order to reduce the current in the capacitor to the minimum before disconnecting it.

In a preferred implementation, the ballast can communicate with an control unit through a wired or wireless link for performance monitoring and remote failure detection.

In another aspect, the invention also relates to luminaries that fit in with multiple standard fluorescent tubes containing mercury vapor gas and heating cathodes located at both ends, and consisting of a fixture including tube connection/holding devices and a ballast for operating fluorescent tubes.

The luminary according to the invention differs from existing systems by the fact that it uses voltage pulses applied to the electrodes for exciting the fluorescent gas, such pulses consisting of non periodic voltage levels separated by variable duration dead times.

In a particularly preferred implementation form of the invention, the ballast can be advantageously adapted to generate pulses composed of alternate voltage amplitude. The ballast is also able to control the timing of pulses as well as the dead times by using programmed algorithms. In an even more preferred implementation form, the ballast is adapted to monitor dead time between pulses from real time samplings of the current that crosses gas in the fluorescent tubes. Fluorescent tube's connectors include special couplings that can be activated by the ballast to short cut the cathode's filaments on right time, in order to cancel any current flow through it and so avoid losses of voltage. A capacitor can be connected to increase the voltage at ends of every fluorescent tube allowing to ignite the conduction through the gas, and can be disconnected as soon as the conduction establishes. In this case, the ballast can be adapted further to modify the current in the tube after the conduction happens in order to reduce the current in the capacitor to the minimum before disconnecting it.

It is particularly appropriate when many luminaries are used in a single place that the ballasts have on line or wireless link with a central control unit, for performance monitoring and remote failure detection.

In some implementation, the ballast includes two parts, the first being a standard ballast operating at normal main power supply voltage, and the second being specifically designed to operate with the non periodic pulses as described in the invention.

The invention is also presented under a third form, namely as a voltage supply signal for the fluorescent tubes in normal operating condition, which signal being formed of pulses characterized by including non periodic voltage levels separated by variable length dead times. Preferably, the signal pulses are of alternative nature i.e. the signal includes equal amplitudes of positive and negative polarity.

The invention will be developed more in detail below, by means of examples of implementation form, and it will refers to the diagrams attached, where:

FIG. 1 represents a simplified traditional diagram of a fluorescent tube with a magneto-inductive ballast and a starter,

FIG. 2 represents a comparison between a conventional magneto-inductive ballast and the new ballast according to the present invention,

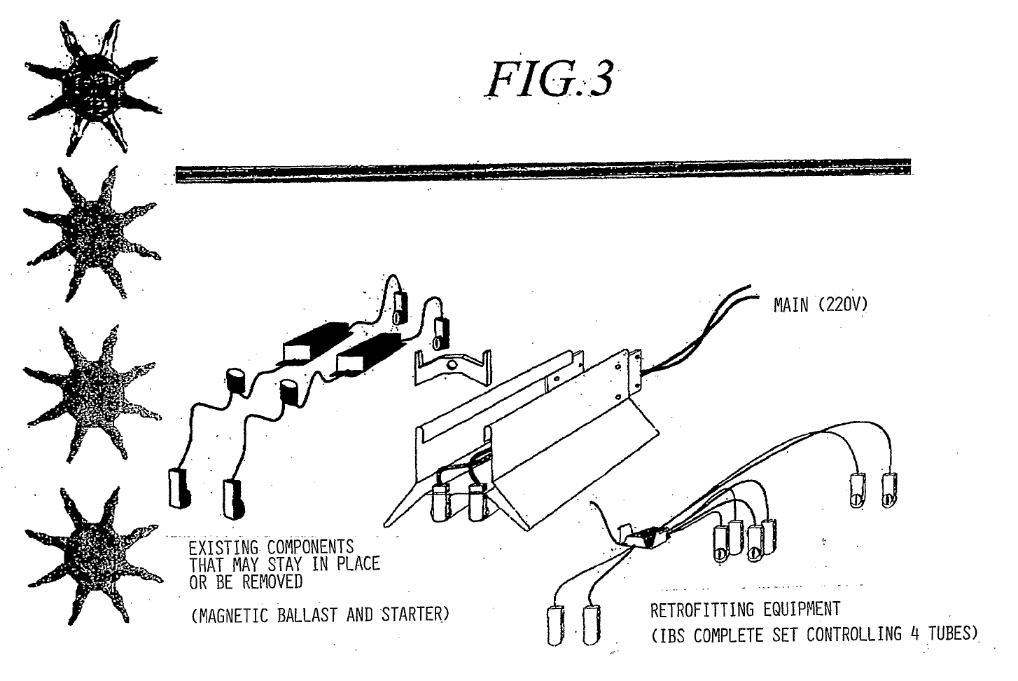

FIG. 3 shows schematically how the new ballast according to the present invention is installed in an existing luminary,

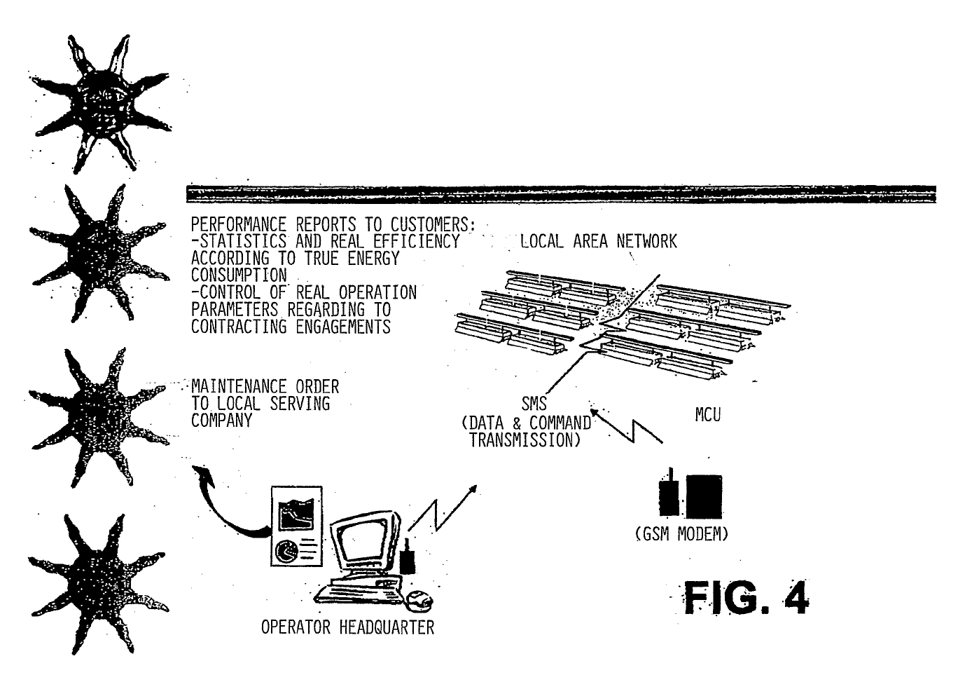

FIG. 4 shows schematically how a set of luminaries can interconnect in a network for remote monitoring.

FIG. 1 in appendix represents the simplest shape of a magneto-inductive type ballast in series with a fluorescent tube, in which the electric main voltage supplies the tube with a frequency of 50 or 60 Hz. This kind of ballast with possibly some minor evolutions, are mostly used in today luminaries. Although some manufacturers are seeking to market new electronic ballasts since a while, luminaries equipped with such electronic ballasts have higher costs that significantly restrain a broad diffusion of these technologies.

The present invention characterizes a new kind of electronic ballast different from existing systems by the fact that it is intended to replace the conventional magnetic ballast in existing luminaries without need of removing the original magnetic ballast when installing the ballast from the invention.

FIG. 2 schematically represents the action of the new ballast designed with the invention. The operation of a fluorescent tube equipped with conventional magnetic ballast is illustrated in the upper part of FIG. 2. It shows that the excitation of mercury atoms by the collision of an electron flowing between the pre-heating electrodes occurs randomly and relatively seldom (cf the only collision represented inducing light radiation).

At the opposite, the bottom of FIG. 2 represents the action of the new ballast working with voltage levels of a very different nature. The latter induces much more collisions and consequently excites more mercury atoms. This phenomenon is illustrated on the figure by three collisions leading to higher ultraviolet radiation. The efficiency increases from the standard level of 65 lumens per unit of power (Watt) for the conventional magnetic ballast to a value of 120 lumens per Watt by using the new ballast from the invention.

The main point concerning the impact of the new ballast on the lighting efficiency is that the ignition voltage applied to a fluorescent tube, i.e. from one electrode to the other, is a high frequency alternative voltage consisting in non periodic pulses separated by variable duration dead times. This special voltage waveform is generated so that every dead time (time of no voltage) is monitored from real time samplings of the current flow crossing the tube. The current intensity depends on a resonance effect in the gas that significantly increases the number of collisions between electrons and mercury atoms. By using this resonance phenomenon, the power consumption can be considerably reduced. The high frequency voltage is used to be just sufficient to maintain the resonance and the voltage level is void as long as the resonance phenomenon maintains the light emission. The current measurement reveals instantaneously the resonance effect, allowing the microprocessor included in the ballast to monitor the voltage waveform in real time.

The voltage pulses are preferably of completely alternative form, i.e. using voltages of same amplitudes and opposite polarity, and are non periodic events. The waveform is real time controlled through programmed algorithms, embedded in the ballast's microprocessor.

These algorithms refer preferably to measurements of the current crossing the plasma in the tube for controlling particularly the dead time duration between pulses according to the value of the current level. The current is continuous real time sampling.

As appearing in FIG. 3, an existing luminary is equipped with a new kit of components, especially designed to fit the luminary. This new kit includes in addition to the electronic ballast from the invention, new tube connectors that are inserted in place of the original plugs. The old components are left in place (i.e. magnetic ballast and starter) and the new ballast is connected to the main power supply bus by using quick coupling devices.

The new connectors include preferably special coupling devices the new ballast can activated to short cut the filaments of the cathodes in order to void any current flow through them and thus cancel losses of voltage.

To ignite conduction in the fluorescent tube, a capacitor is briefly connected in parallel with the tube in order to increase the voltage between the electrodes. As soon as conduction is produced through the mercury vapor, the capacitor is disconnected. The ballast adapts the current through the mercury vapor once conduction occurs, in a way that current crossing the capacitor is reduced to the minimum before removing the capacitor.

The new operating mode of fluorescent tube as described is based on the principle aiming to increasing the number of collisions between electrons and mercury atoms in molecular excitation of plasma medium where a new voltage waveform improves the lighting energy efficiency. The high frequency alternate signal that is used comprises accurate monitored dead time phases that contribute to reduce energy consumption to the minimum.

The process is optimized by constant monitoring of the current flowing through the tube and continuous regulation of the dead time, according to the programmed functions that supervise the conditions and physical parameters coupling voltage variations and collision rate between electrons and mercury atoms.

The program is included in an electronic device placed in the new ballast that is installed in luminaries. This electronic device looks like a “macrochip” electronic component including all processes of controlling and monitoring functions. The electronic device consists of a controller (central processing unit) which integrates the software in a secured and protected chip also containing coded functions which make it available only under precise conditions, in order to avoid any undesired access to the operation and program.

It should be noted that frequencies and voltage waveforms are in a much higher range of frequency than the main supply. In addition, it should be underlined that the variations of voltage are non sinusoidal and not periodic. The voltage variation includes dead time phases in which current in the tube is void. Because of this particular operating mode, it is not necessary that some current crosses the filaments of electrodes for maintaining the flow of electrons in the tube.

Because of appearance of a resonance phenomenon increasing the number of collisions between electrons generated by cathodes and mercury atoms in the gas, the operating mode according to the invention as stated above, reduces the operating temperature and improves electronic ballast reliability.

Optimal operation is reached thanks to controlled pre-heating of cathodes and specific excitation mode during ignition of conduction of the vapor whatever the temperature in the tube. The nominal running mode is thus reached gradually, as the resonance phenomenon maintained by the process stabilizes. During this phase of progressive transformation which requires a few minutes, the current crossing the tube increases, as well as the emission of light, by successive steps. At the end of this phase, the phenomenon of resonance is stable according to the specific environmental conditions. Current decreases gradually and reaches a minimum average value after approximately 15 minutes.

Thanks to the use of the procedure according to the invention, the temperature of the electrodes can be lowered by more than 40° C., which has a significant incidence over the lifespan of the tube.

FIG. 4 shows how a greater number of luminaries, each of them integrating the new ballast, is connected via a special communication bus to a central control unit. This unit can be local or remote, as shown on FIG. 4. In this example, a wireless connection in the form of SMS messages using GSM is used. In this type of control unit, the performance of the lighting system of a site can be recorded and the operation be permanently and remotely monitored in case of a breakdown. This makes it possible to provide to the users statistics and reports of precise operations statistics and reports stating amongst other things the energy consumption while making it possible to intervene more quickly when maintenance is necessary.

1. Operating mode for fluorescent tubes, such luminaries including one or more standard fluorescent tubes that contain mercury vapor gas and heating filament cathodes at ends, a fixture that integers proper holding and connection devices for fluorescent tubes and one ballast for driving the fluorescent tubes. Ballast operating mode differs from existing systems by the fact that it uses voltage pulses applied to the electrodes for exciting the fluorescent gas, such pulses consisting of non periodic voltage levels separated by variable duration dead times.

2. Operating mode according to claim 1, characterized in that the ballast produces alternative voltage pulses.

3. Operating mode according to claim 1, characterized in that the ballast monitors the voltage signals as well as dead times by means of a programmed algorithm.

4. Operating mode according to claim 1, characterized in that the ballast monitors each dead times duration according to real time samplings of the current crossing gas in the fluorescent tubes.

5. Operating mode according to claim 1, characterized in that the special couplings of connexion/fixation of the fluorescent tubes are activated by the ballast in order to short cut the filaments of the electrodes of the fluorescent tubes in such a way to cancel the current though them and to thus avoid the losses in voltage.

6. Operating mode according to claim 1, characterized in that conduction through gas of the fluorescent tubes is ignited by the temporary connection of a capacitor making it possible to increase the tension between the electrodes of each fluorescent tube and that this capacitor is disconnected as soon as conduction is obtained.

7. Operating mode to according to claim 6, characterized in that the ballast modifies the current level crossing the gas in such way that the current crossing the capacitor is minimized before the disconnection of the capacitor.

8. Operating mode according to claim 1, characterized in that the ballast communicates with a remote central control unit through a wired or wireless link for performance monitoring and remote failure detection.

9. Luminary for fluorescent tubes, such luminary including one or more standard fluorescent tubes that contain mercury vapor gas and heating filament cathodes at ends, a fixture that integers proper holding and connection devices for fluorescent tubes and one ballast for driving the fluorescent tubes. Ballast operating mode differs from existing systems by the fact that it uses voltage pulses applied to the electrodes for exciting the fluorescent gas, such pulses consisting of non periodic voltage levels separated by variable duration dead times.

10. Luminary for fluorescent tubes according to claim 9, characterized in that the ballast is adapted to produce voltage pulses in an alternative form.

11. Luminary for fluorescent tubes according to claim 9, characterized in that the ballast produces the voltage signals as well as dead time by means of programmed algorithms.

12. Luminary for fluorescent tubes according to claim 9, characterized in that the ballast is adapted to monitor each dead time duration according to real time samplings of the current through the fluorescent tubes gas.

13. Luminary for fluorescent tubes according to claim 9, characterized in that the holdings of connexion/fixings of the fluorescent tubes comprise special couplings being able to be activated by the ballast to short cut the electrodes filament of the fluorescent tubes in order to cancel the current.

14. Luminary for fluorescent tubes according to claim 9, characterized in that a capacitor can be connected in order to increase the voltage between the electrodes of each fluorescent tube in order to start conduction through gas, such capacitor being disconnected as soon as conduction is obtained.

15. Luminary for fluorescent tubes according to the claim 14, characterized in that the ballast is adapted to modify the current crossing of the fluorescent tube gas when conduction is obtained, in such a way that the current in the capacitor is reduced at its lowest level before the disconnection of such capacitor.

16. Luminary for fluorescent tubes according to claim 9, characterized in that the ballast has a wire or wireless connection enabling him to communicate with a remote control unit for performance monitoring and remote failure detection.

17. Luminary for fluorescent tubes according to claim 9, characterized in that the ballast includes two parts; the first being a standard ballast functioning simply with the main sector and the second being a specifically assembled part to work with the non periodic pulses characterizing the invention of this patent.

18. Signal of supply voltage of the fluorescent tubes in normal operating conditions made of pulses and characterized in that this signal includes non periodic pulses and variable dead times durations.

19. Signal of supply voltage according to claim 18, characterized in that the signal pulses are of alternative form i.e. including amplitudes of equal values but of positive and negative polarity.
